(19) United States
(12) Patent Application Publication
(10) Pub. No.: US 2026/0010789 A1
(43) Pub. Date: Jan. 8, 2026

(54) MACHINE LEARNING DEVICE, ELECTRONIC DEVICE, MACHINE LEARNING PROGRAM, AND SIMULATION DEVICE

(71) Applicant: ROHM CO., LTD., Kyoto-shi (JP)

(72) Inventor: Kenji HAMACHI, Kyoto-shi (JP)

(21) Appl. No.: 19/249,082

(22) Filed: Jun. 25, 2025

(30) Foreign Application Priority Data
Jul. 3, 2024 (JP) 2024-107459

(51) Int. Cl. G06N 3/08; G06N 3/04

(52) U.S. Cl. CPC G06N 3/08; G06N 3/04

(57) ABSTRACT

A machine learning device includes a model holding section and a calculation section. The model holding section is configured to hold a machine learning model. The calculation section calculates a first calculation result by inputting input data to the machine learning model so as to perform inference, calculates a second calculation result by inputting output data of the first calculation result to the machine learning model so as to perform inference, and calculates an intermediate layer error on the basis of first intermediate data included in the intermediate layer of the first calculation result and second intermediate data of the second calculation result.

### CROSS-REFERENCE TO RELATED APPLICATIONS

The present invention claims priority under 35 U.S.C. § 119 to Japanese Patent Application No. 2024-107459 filed on Jul. 3, 2024, the entire contents of which are hereby incorporated by reference

### BACKGROUND OF THE INVENTION

### Field of the Invention

The present disclosure relates to a machine learning device, an electronic device, a machine learning program, and a simulation device.

### Description of Related Art

Conventionally, an application of artificial intelligence (AI) to Condition Based Maintenance of a machine system has been proceeded for a plant and equipment maintenance in an industrial field.

### SUMMARY OF THE INVENTION

An abnormality level calculation method according to one aspect of the present disclosure is an abnormality level calculation method using a machine learning device. The machine learning device includes a model holding section configured to hold a machine learning model including an input layer, an output layer, and at least one intermediate layer disposed between the input layer and the output layer, and a calculation section that inputs predetermined input data to the machine learning model so as to calculate a calculation result by performing inference, and is configured to be capable calculating an intermediate layer error on the basis of a plurality of calculation results. This abnormality level calculation method includes steps of calculating a first calculation result as the calculation result, by inputting first input data as the input data to the machine learning model so as to perform inference; calculating a second calculation result as the calculation result, by inputting output data included in the output layer in the first calculation result to the machine learning model so as to perform inference; and calculating an intermediate layer error, on the basis of first intermediate data included in the intermediate layer of the first calculation result, and second intermediate data included in the intermediate layer of the second calculation result.

In addition, an electronic device of the present disclosure includes the machine learning device having the above configuration.

In addition, a machine learning program of the present disclosure is a program that realizes a function of the machine learning device having the above configuration.

In addition, a simulation device of the present disclosure calculates output data and an intermediate layer error using the machine learning device having the above configuration.

### BRIEF DESCRIPTION OF THE DRAWINGS

FIG. 1 is a diagram illustrating a configuration of a computer.

FIG. 2 is a block diagram illustrating a configuration of a machine learning device according to a first embodiment of the present disclosure.

FIG. 3 is a diagram illustrating a configuration of a machine learning model.

FIG. 4 is a diagram schematically illustrating an embodiment of generating an input-output error and a hidden layer error, using input data and the machine learning model.

FIG. 5 is a graph illustrating an example of the input data.

FIG. 6 is a graph illustrating an enlargement of a part of FIG. 5.

FIG. 7 is a graph illustrating an enlargement of a part of FIG. 5.

FIG. 8 is a graph illustrating an input-output error when the input data is input to the machine learning model, and a calculation result of the hidden layer error.

FIG. 9 is a flowchart of an abnormality level calculation method using the machine learning device.

FIG. 10 is a flowchart illustrating a detailed configuration of a first calculation step.

FIG. 11 is a flowchart illustrating a detailed configuration of a second calculation step.

### DETAILED DESCRIPTION OF THE PREFERRED EMBODIMENTS

Hereinafter, with reference to the drawings, an embodiment of the present disclosure is described.

### Computer 100

First, described is a computer 100 that functions as a machine learning device 6 of the present disclosure. Next, the machine learning device 6 of a first embodiment according to the present disclosure is described in detail.

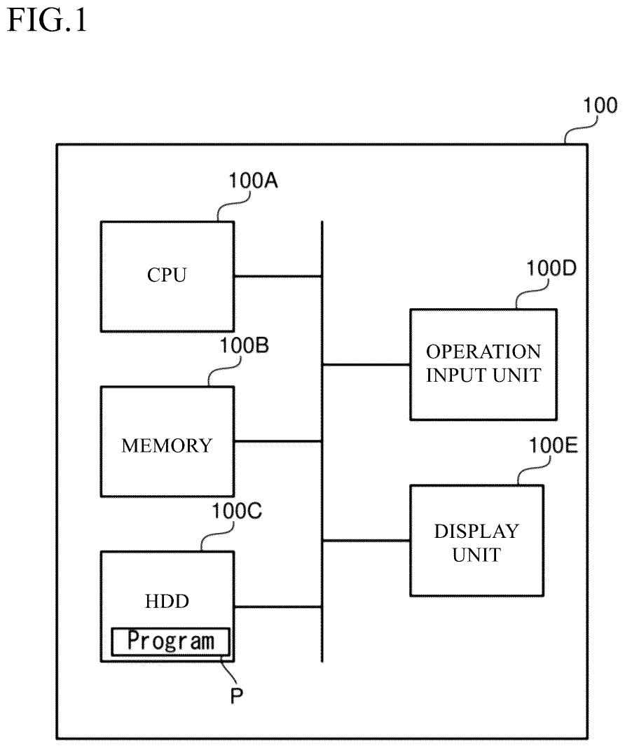

FIG. 1 is a diagram illustrating a configuration of the computer 100. The computer 100 functions as the machine learning device 6 that will be described later. The computer 100 is a personal computer (PC), for example.

The computer 100 includes a central processing unit (CPU) 100A, a memory 100B, an auxiliary storage device 100C, an operation input unit 100D, and a display unit 100E.

The CPU 100A includes a control device and a calculation device (which are not shown). The control device interprets commands in a program, so as to control each unit of the computer 100. The calculation device performs a calculation process.

The memory 100B is a semiconductor storage device that temporarily stores a program or data. Information stored in the memory 100B is erased when the computer 100 is powered off.

The auxiliary storage device 100C is constituted of a hard disk drive (HDD), a solid state drive (SSD), or the like, so as to store the program or data. The program stored in the auxiliary storage device 100C is read into the memory 100B. The CPU 100A executes the program read into the memory 100B.

Here, the auxiliary storage device 100C stores a simulation program P. The simulation program P is a program that allows the computer 100 to function as the machine learning device 6 described later. Details of the machine learning device 6 will be described later.

The operation input unit 100D is a device constituted of a keyboard, a mouse or the like, so as to provide the computer 100 with an operation input. Information input from the operation input unit 100D is sent to the memory 100B.

The display unit 100E is constituted of a liquid crystal display, for example, and converts the information obtained from the memory 100B into image so as to output the image.

### Machine Learning Device 6 of Embodiment

Next, the machine learning device 6 of the embodiment according to the present disclosure is described. The machine learning device 6 is constituted of a micro controller unit (MCU). The machine learning device 6 is incorporated in a predetermined machine system (such as a motor device), so as to perform control of this machine system. In addition, the machine learning device 6 can perform not only the control of the machine system but also machine learning using various data of this machine system as input data.

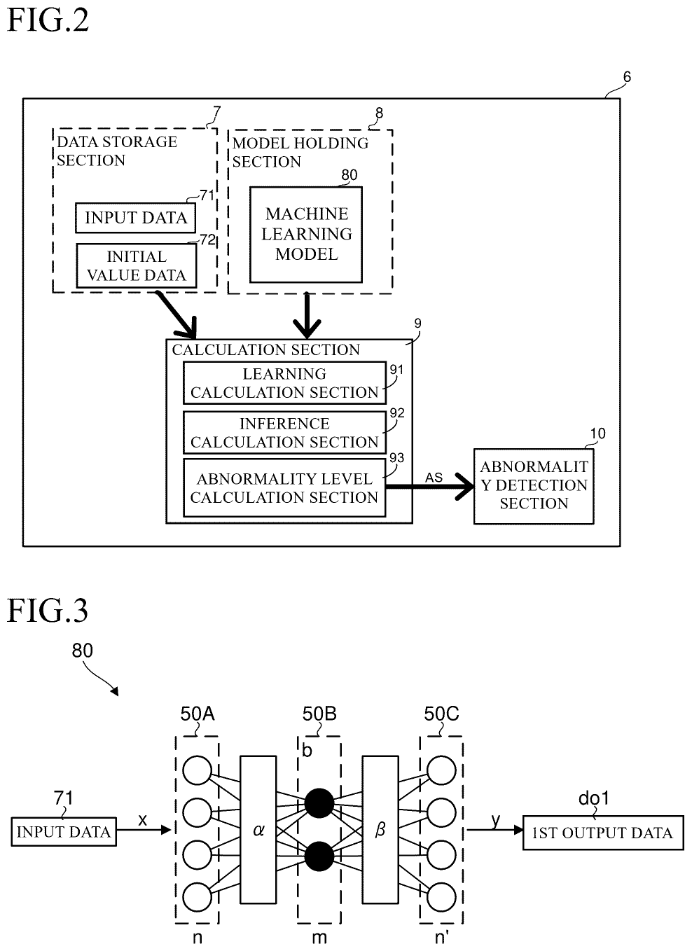

FIG. 2 is a block diagram illustrating a configuration of the machine learning device 6 according to the first embodiment of the present disclosure. As illustrated in FIG. 2, the machine learning device 6 includes a data storage section 7, a model holding section 8, a calculation section 9, and an abnormality detection section 10.

The data storage section 7 stores input data 71 and initial value data 72. The input data 71 is, for example, time series data output from the machine system or the like. A preprocess such as a normalization process or FFT may be performed on the time series data as necessary. An initial value determined by the computer 100 as described above is set in the initial value data 72.

The model holding section 8 holds a machine learning model 80. The machine learning model 80 is a machine learning model that can learn and infer in accordance with the input data. Details of the machine learning model 80 will be described later.

The calculation section 9 calculates a first calculation result 30 using the input data 71 and the machine learning model 80. The first calculation result 30 includes first output data do1, an input-output error da1, and a first hidden layer vector ha, which will be described later. In addition, the calculation section 9 calculates a second calculation result 31 using the first output data dol and the machine learning model 80. The calculation section 9 is specifically described as follows.

The calculation section 9 includes a learning calculation section 91, an inference calculation section 92, and an abnormality level calculation section 93. The learning calculation section 91 performs unsupervised learning using the machine learning model 80, the input data 71, and the initial value data 72.

The inference calculation section 92 performs inference using the machine learning model 80, the input data 71, and the initial value data 72. The inference can be performed when the learning calculation section 91 performs learning, and after the learning is finished.

The abnormality level calculation section 93 calculates the input-output error da1 and a hidden layer error da3, using the input data 71 and the machine learning model 80. The abnormality level calculation section 93 sends to the abnormality detection section 10 the calculated input-output error da1 and hidden layer error da3 as a calculation result AS.

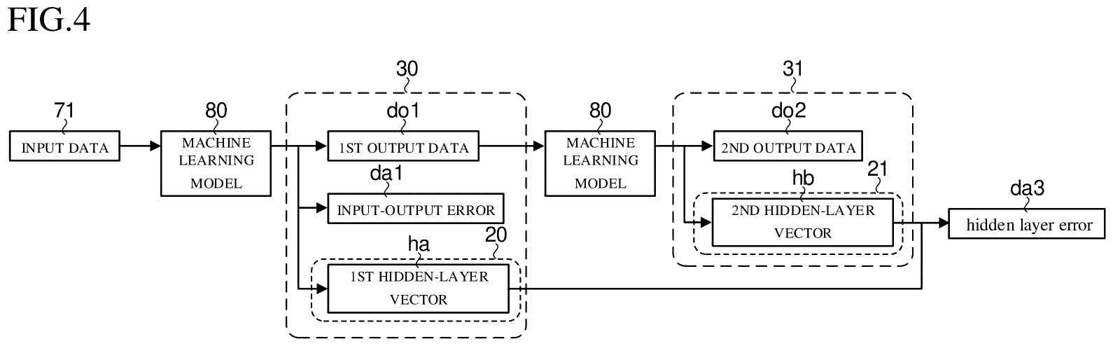

The input-output error da1 is an error between a value included in an input layer 50A (i.e., the input data 71) and a value included in an output layer 50C (i.e., the first output data do1), when the inference is performed by inputting the input data 71 to the machine learning model 80, and it is calculated by a loss function that will be described later. The hidden layer error da3 is an error between first intermediate data 20 (see FIG. 4 referred to later) and second intermediate data 21 (see FIG. 4 referred to later), and it is calculated by the loss function that will be described later.

The first intermediate data 20 is a value included in a hidden layer 50B, when the inference is performed by inputting the input data 71 to the machine learning model 80. Here, the first hidden layer vector ha is handled as the first intermediate data 20. The first hidden layer vector ha is a feature vector of the hidden layer 50B, when the inference is performed by inputting the input data 71 to the machine learning model 80.

The second intermediate data 21 is a value included in the hidden layer 50B, when the inference is performed by inputting the first output data do1 to the machine learning model 80. Here, a second hidden layer vector hb is handled as the second intermediate data 21. The second hidden layer vector hb is the feature vector of the hidden layer 50B, when the first output data do1 is input to the machine learning model 80.

In a case where the input data 71 is time series data that repeats at a predetermined period, if there is a change in tendency of the data in repetition, each of the input-output error da1 and the hidden layer error da3 may also change. In this case, the input-output error da1 and the hidden layer error da3 may have different tendencies or may have similar tendencies. Details of a method for calculating the input-output error dal and the hidden layer error da3 will be described later.

The abnormality detection section 10 receives the calculation result AS from the abnormality level calculation section 93, and detects whether or not there is an abnormality in the input data 71, from data included in the calculation result AS. Specifically, the abnormality detection section 10 refers to tendency of each of the input-output error da1 and the hidden layer error da3, determines whether or not there is a change in the tendency of data over time, and if there is a change, it determines abnormality. The abnormality detection section 10 outputs the detection result to the outside. As described above, when the computer 100 functions as the machine learning device 6, the abnormality detection section 10 outputs the detection result to the display unit 100E.

Next, the machine learning model 80 is described in detail. FIG. 3 is a diagram illustrating a configuration of the machine learning model 80. The machine learning model 80 is an inference model that can be learned using predetermined learning data. As illustrated in FIG. 3, the machine learning model 80 includes a three-layered neural network 50.

The three-layered neural network 50 is an AI model including the input layer 50A, the hidden layer 50B, and the output layer 50C. The hidden layer 50B is also referred to as an intermediate layer. In general, in the three-layered neural network 50, with respect to n-dimension input data x∈Rk×n having a batch size of k, n′-dimension inference result y∈Rk×n′ is obtained as y=G(x·α+b)β. Here, α∈Rn×m is a weight connecting the input layer 50A and the hidden layer 50B. β∈Rm×n′ is a weight connecting the hidden layer 50B and the output layer 50C. In addition, b∈Rm is a bias of the hidden layer 50B. G is an activating function of the hidden layer 50B. As the activating function, for example, Sigmoid, ReLU, or the like can be used.

The three-layered neural network 50 adopts an algorithm capable learning sequentially with an arbitrary batch size. When the i-th learning data {xᵢ∈Rkᵢ×n, tᵢ∈Rkᵢ×n′} having a batch size of kᵢ is obtained, it is necessary to determine βᵢ that minimizes the error expressed by the following expression (1).

$$\begin{matrix}[ Mathematical 1 ] & \\ ‖ [ \begin{matrix}{H}_{0} \\ ⋮ \\ {H}_{i}\end{matrix} ] {β}_{i} - [ \begin{matrix}{t}_{0} \\ ⋮ \\ {t}_{i}\end{matrix} ] ‖ & ( 1 )\end{matrix}$$

Note that the i-th hidden layer matrix is Hᵢ=G(xᵢ·α+b). In addition, t is training data corresponding to the inference result y.

The optimized weight βᵢ is calculated by the following equation (2).

$$\begin{matrix}{P}_{i} = {P}_{i - 1} - {P}_{i - 1} {{H}_{i}^{T} ( I + {H}_{i} {P}_{i - 1} {H}_{i}^{T} )}^{- 1} {H}_{i} {P}_{i - 1} \\ {β}_{i} = {β}_{i - 1} + {P}_{i} {H}_{i}^{T} ( {t}_{i} - {H}_{i} {β}_{i - 1} )\end{matrix} \qquad ( 2 )$$

Here, P₀ and β₀ are obtained by the following equation (3).

$$\begin{matrix}{P}_{0} = {( {H}_{0}^{T} {H}_{0} )}^{- 1} \\ {β}_{0} = {P}_{0} {H}_{0}^{T} {t}_{0}\end{matrix} \qquad ( 3 )$$

The learning algorithm is as follows.
(1) Initialize the values of the weight α and the bias b using a random number.
(2) Calculate H₀ for x₀ and calculate P₀ and β₀.
(3) Calculate Pᵢ and βᵢ sequentially every time when the i-th learning data of the batch size of kᵢ is obtained. Note that it may be possible to set the value initialized by a random number as β₀, without using the equation for calculating β₀ in the equation (3).

A bottleneck of calculation amount in the above equation (2) is (I+HᵢPᵢ₋₁Hᵢ^{T})⁻¹, and because matrix size of (I+HᵢPᵢ₋₁Hᵢ^{T}) is k×k, if k=1 holds, inverse matrix calculation can be replaced by inverse number calculation. Therefore, by fixing the batch size to k=1, even a microcomputer-level calculation device can easily perform the calculation.

In addition, the machine learning model 80 of this embodiment performs leaning using an autoencoder. The autoencoder diverts the input data as it is as the training data and performs learning so that the input data can be reconfigured as the inference result. In other words, in the above description, learning is performed as t=x. The autoencoder does not require to create training data separately and hence is a type of the unsupervised learning algorithm. In addition, by setting the number of nodes of the hidden layer to be smaller than that of the input layer and the output layer, when an error between the input data and the inference result is converged, the hidden layer matrix can be regarded as a dimension compression format of the input data. In other words, the encode result of the input data x is H=G(x·γ+b), and the decode result of His obtained as y=H·t.

FIG. 4 is a diagram schematically illustrating an embodiment of generating the input-output error da1 and the hidden layer error da3, using the input data 71 and the machine learning model 80.

As illustrated in FIG. 4, by inputting the input data 71 to the machine learning model 80 so as to calculate by the calculation section 9, the first calculation result 30 can be obtained. The first calculation result 30 includes the first output data do1, the input-output error da1, and the first hidden layer vector ha. The specific description is as follows.

By inputting the input data 71 to the machine learning model 80 so as to perform inference by the inference calculation section 92, the first output data do1 is obtained as the inference result. In addition, in this case, the abnormality level calculation section 93 calculates the input-output error da1. In addition, as the feature vector of the hidden layer 50B in this case, the first hidden layer vector ha is obtained.

Further, by inputting the first output data do1 to the machine learning model 80 so as to calculate by the calculation section 9, the second calculation result 31 can be obtained. The second calculation result 31 includes a second output data do2 and the second hidden layer vector hb. The specific description is as follows.

By inputting the first output data do1 to the machine learning model 80 so as to perform inference by the inference calculation section 92, the second output data do2 is obtained as the inference result. In addition, as the feature vector of the hidden layer 50B in this case, the second hidden layer vector hb is obtained.

Further, the hidden layer error da3 is calculated by the abnormality level calculation section 93, on the basis of the first hidden layer vector ha and the second hidden layer vector hb. Details of the calculation method in this case will be described later.

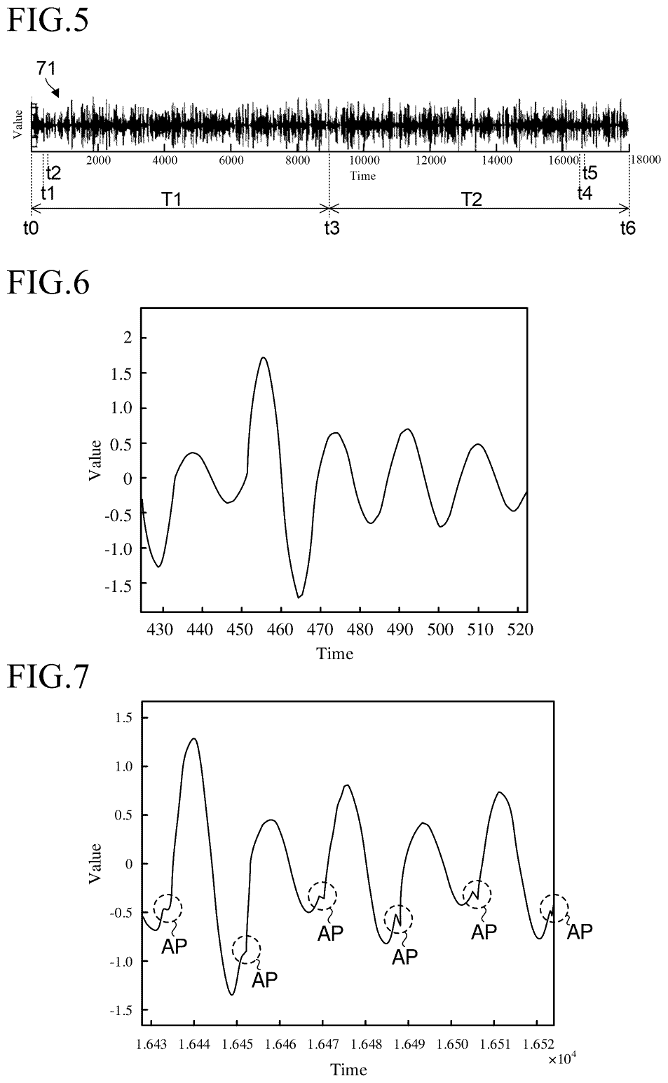

FIG. 5 is a graph illustrating an example of the input data 71. FIG. 5 illustrates the input data 71 as a time series graph, in which the horizontal axis is time, while the vertical axis is a predetermined output value. FIG. 6 is a graph illustrating an enlargement of a part from time point t1 to time point t2 in FIG. 5. FIG. 7 is a graph illustrating an enlargement of a part from time point t4 to time point t5 in FIG. 5.

In FIG. 5, a start point of the data is time point t0, and an end point of the data is time point t6. In addition, in FIG. 5, the period from time point t0 to time point t3 is a normal period T1. In addition, in FIG. 5, the period from time point t3 to time point t6 is an abnormal period T2.

The normal period T1 means a period where there is no abnormality in the input data 71. In other words, the normal period T1 is a period where it is estimated that no specific abnormality has occurred in the output value of the machine system mounting the machine learning device 6. On the other hand, the abnormal period T2 means a period where there is an abnormality in the input data 71. In other words, the abnormal period T2 is a period where it is estimated that a certain abnormality has occurred in the output value of the machine system mounting the machine learning device 6.

As illustrated in FIGS. 5 and 6, the input data 71 in the normal period T1 has a waveform like a sine wave repeating at a certain period. On the other hand, as illustrated in FIGS. 5 and 7, the input data 71 in the abnormal period T2 has a waveform repeating at a certain period, but there is an abnormal point (hereinafter, also referred to as an abnormal point Ap) in the second half of one period of the waveform.

However, as illustrated in FIG. 5, it is difficult for a user to determine whether or not there is an abnormality in the input data 71, at a glance of the input data 71. Enlarging the graph of the input data 71 as illustrated in FIG. 7 may be of some help for the determination, but it will be complicated.

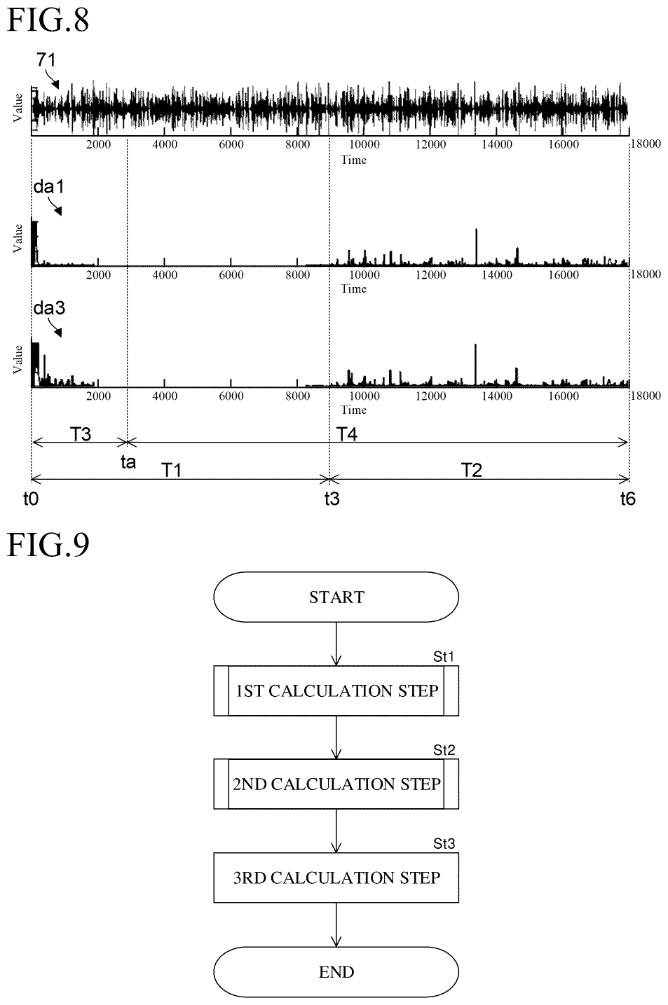

FIG. 8 is a graph illustrating calculation results of the input-output error da1 and the hidden layer error da3, when the input data 71 is input to the machine learning model 80. In FIG. 8, the input-output error da1 and the hidden layer error da3 are illustrated as time series graphs, in which the horizontal axis is time, while the vertical axis is a predetermined value.

The period from time point t0 to time point ta in FIG. 8 is referred to as a learning period T3. The learning period T3 is a period where leaning is performed by inputting the input data 71 to the machine learning model 80. The period from time point ta to time point t6 is referred to as an inference period T4. The inference period T4 is a period where inference is performed by inputting the input data 71 to the machine learning model 80.

In the learning period T3, fetching or the like of features of the input data 71 is performed. For this reason, the data value (i.e., the value on the vertical axis) of each of the input-output error da1 and the hidden layer error da3 changes largely. The learning period T3 is an unstable period where the input-output error da1 and the hidden layer error da3 sharply respond to a change of the input value, and it is not suitable for detecting an abnormal value of the input data 71.

As illustrated in FIG. 8, during the inference period T4 and during the normal period T1, the input-output error da1 and the hidden layer error da3 are both remained in similar values, without a large variation.

On the other hand, during the abnormal period T2, the input-output error da1 has a large variation of the data tendency, compared with the normal period T1. Specifically, compared with the normal period T1, the data value rises steeply and with high frequency. The same is true for the hidden layer error da3. From this fact, it can be estimated that there is a certain change of tendency, i.e., an abnormality in the input data 71 in the normal period T1 and the abnormal period T2.

When the abnormality detection section 10 detects the change of tendency generated in the input-output error da1 or the hidden layer error da3, it outputs the same as the detection result. As a method of output, for example, it is possible to adopt a method of displaying warning, alarm, or the like on the display unit 100E.

The user checks or analyzes the detection result output from the abnormality detection section 10, and hence can determine whether or not the input data 71 includes an abnormal value, i.e., whether or not an abnormality has occurred in the machine system or the like mounting the machine learning device 6.

### Input-Output Error da1

Next, the input-output error da1 and the hidden layer error da3 are described in detail. The input-output error da1 indicates an error between the first output data do1 and the input data 71. The first output data do1 is data of the inference result obtained as a result of inference by inputting the input data 71 to the machine learning model 80. The input-output error da1 is calculated by the loss function on the basis of the input data 71 and the first output data do1. The specific description is as follows.

Each input value included in the input data 71 is referred to as an input value x. In addition, each output value (each value of the inference result) included in the first output data do1 is referred to as an output value y. As the loss function for calculating the input-output error da1, for example, mean absolute error (MAE), mean squared error (MSE), or the like can be adopted. If the loss function is MAE, a loss function L can be expressed by the following equation (4).

$$\begin{matrix}[ Mathematical 2 ] & \\ L ( y , x ) = \frac{1}{n ′} \sum \vert y - x \vert & ( 4 )\end{matrix}$$

In addition, if the loss function is MSE, the loss function L is expressed as the following equation (5).

$$\begin{matrix}[ Mathematical 3 ] & \\ L ( y , x ) = \frac{1}{n ′} \sum {\vert y - x \vert}^{2} & ( 5 )\end{matrix}$$

### Hidden Layer Error Da3

The hidden layer error da3 is calculated on the basis of the first hidden layer vector ha and the second hidden layer vector hb. The specific description is as follows.

The first hidden layer vector ha is the feature vector of the hidden layer 50B when the inference is performed by inputting the input data 71 to the machine learning model 80. The first hidden layer vector ha is expressed by the following equation (6).

$$\begin{matrix}[ Mathematical 4 ] & \\ {h}_{a} = ( \begin{matrix}{h}_{a 1} \\ {h}_{a 2} \\ ⋮ \\ {h}_{am}\end{matrix} ) & ( 6 )\end{matrix}$$

The second hidden layer vector hb is the feature vector of the hidden layer 50B when the inference is performed by inputting the first output data dol to the machine learning model 80. The second hidden layer vector hb is expressed by the following equation (10).

$$\begin{matrix}[ Mathematical 5 ] & \\ {h}_{b} = ( \begin{matrix}{h}_{b 1} \\ {h}_{b 2} \\ ⋮ \\ {h}_{bm}\end{matrix} ) & ( 10 )\end{matrix}$$

The hidden layer error da3 is calculated by the loss function L that indicates an error between the first hidden layer vector ha and the second hidden layer vector hb. If the loss function is MAE, the loss function L is expressed as the following equation (11).

$$\begin{matrix}[ Mathematical 6 ] & \\ L ( {h}_{b} , {h}_{a} ) = \frac{1}{n ′} \sum \vert {h}_{b} - {h}_{a} \vert & ( 11 )\end{matrix}$$

In addition, if the loss function is MSE, the loss function L is expressed as the following equation (12).

$$\begin{matrix}[ Mathematical 7 ] & \\ L ( {h}_{b} , {h}_{a} ) = \frac{1}{n ′} \sum {\vert {h}_{b} - {h}_{a} \vert}^{2} & ( 12 )\end{matrix}$$

As described above, by calculating the input-output error da1, the user can determine whether or not the input data 71 includes an abnormal value, i.e., whether or not an abnormality has occurred in the machine system or the like mounting the machine learning device 6.

Further, the abnormality level calculation section 93 generates the hidden layer error da3 in addition to the input-output error da1. Depending on the input data 71, even if an abnormal value is included, a large variation of the data tendency as described above may not be recognized in the input-output error da1. In this case too, by referring to the calculated hidden layer error da3, the user can easily determine whether or not the input data 71 includes an abnormal value.

In addition, as described above, the first hidden layer vector ha is a feature vector indicating a feature of the hidden layer 50B when the inference is performed using the input data 71. On the other hand, the second hidden layer vector hb indicates a feature of the hidden layer 50B when the inference is further performed, using the inference result based on the input data 71 (i.e., the first output data do1). For this reason, even if the input data 71 includes an abnormal value, the second hidden layer vector hb is a feature vector indicating a feature in which the abnormal value is attenuated compared with the first hidden layer vector ha.

The hidden layer error da3 is calculated on the basis of the features of the above two hidden layers (the first hidden layer vector ha and the second hidden layer vector hb). In other words, it can be said to have the same meaning as determining an abnormal value in the input data 71, using information sets of the hidden layer 50B, in which the feature of the input data 71 is concentrated. For this reason, even if only a small change of tendency is recognized in the input-output error da1, a noticeable change may occur in the hidden layer error da3. Therefore, by calculating the hidden layer error da3 in addition to the input-output error da1, an abnormal value in the input data 71 can be detected more easily.

Next, an abnormality level calculation method using the machine learning device 6 is described.

FIG. 9 is a flowchart of the abnormality level calculation method using the machine learning device 6. As illustrated in FIG. 9, a first calculation step is executed first (Step St1). In the first calculation step, the inference is performed by inputting the input data 71 to the machine learning model 80, and the first calculation result 30 is calculated. As described above, the first calculation result 30 includes the first output data do1, the input-output error da1, and the first hidden layer vector ha.

Next, a second calculation step is executed (Step St2). In the second calculation step, the first output data do1 is input to the machine learning model 80, and the inference is performed, so as to calculate the second calculation result 31. As described above, the second calculation result 31 includes the second output data do2 and the second hidden layer vector hb.

Next, a third calculation step is executed (Step St3). In the third calculation step, the hidden layer error da3 is calculated on the basis of the first calculation result 30 and the second calculation result 31. Detailed description of the first calculation step (Step St1) to the third calculation step (Step St3) is as follows.

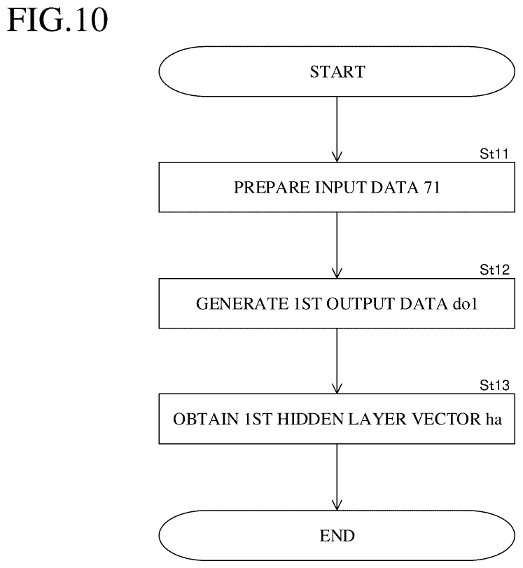

FIG. 10 is a flowchart illustrating a detailed configuration of the first calculation step. As illustrated in FIG. 10, the user first prepares the input data 71 (Step St11). Step St11 includes selection of the input data, extraction, a predetermined preprocess (e.g., statistical processing, FFT analysis, or the like), and the like.

Next, the inference calculation section 92 performs the inference on the basis of the input data 71 and the machine learning model 80, so as to generate the first output data do1 as the inference result (Step St12). Next, the abnormality level calculation section 93 calculates the input-output error da1. In addition, the abnormality level calculation section 93 obtains the first hidden layer vector ha on the basis of the hidden layer 50B (Step St13). Therefore, as the first calculation result 30 after the first calculation step, the first output data do1, the input-output error da1, and the first hidden layer vector ha are generated (see FIG. 4). Then, the process proceeds to a second calculation step (Step St2).

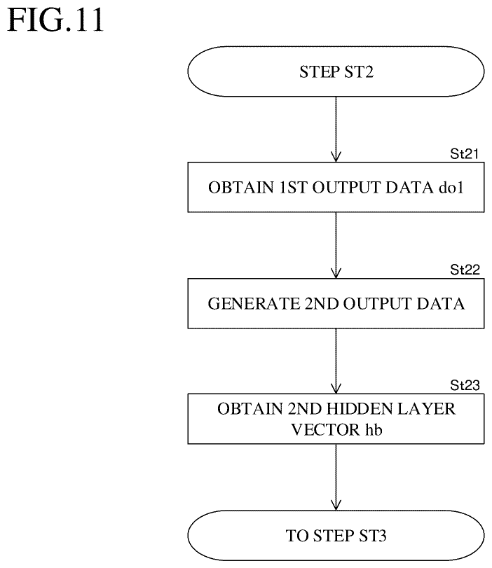

FIG. 11 is a flowchart illustrating a detailed configuration of the second calculation step. As illustrated in FIG. 11, in the second calculation step, the inference calculation section 92 first obtains the first output data do1 from the first calculation result 30 (Step St21). The first output data do1 is data included in the output layer 50C of the machine learning model 80 after the first calculation step. The first output data do1 may be obtained by the inference calculation section 92, or may be obtained by another calculation section, or the user may select the same from the first calculation result 30.

Next, the inference calculation section 92 inputs the obtained first output data do1 to the machine learning model 80, and performs inference again, so as to generate the second output data do2 as the inference result (Step St22). Next, the abnormality level calculation section 93 obtains the second hidden layer vector hb on the basis of the hidden layer 50B (Step St23). Therefore, the second output data do2 and the second hidden layer vector hb are generated as the second calculation result 31 after the second calculation step (see FIG. 4). Then, the process proceeds to a third calculation step (Step St3).

In the third calculation step, the abnormality level calculation section 93 calculates the hidden layer error da3 on the basis of the obtained first hidden layer vector ha and second hidden layer vector hb. Note that the method for calculating the hidden layer error da3 is as described above.

### Variations

Other than that, the present disclosure is not limited to the embodiment described above but can be variously modified within the scope of the present disclosure without deviating from the spirit thereof. For instance, in the configuration according to the above embodiment, the abnormality detection section 10 detects the abnormality level of the input data 71 on the basis of the input-output error da1 and the hidden layer error da3, but this is not a limitation. For instance, it may be possible to output the input-output error da1 and the hidden layer error da3 as graphs like FIG. 8, and to allow the user to visually check this graph, so that the user can check a change of tendency described above and hence determine the abnormality level of the input data 71.

### Additional Notes

A machine learning device (6) comprises a model holding section (8) configured to hold a machine learning model (80) including an input layer (50A), an output layer (50C), and at least one intermediate layer (50B) disposed between the input layer (50A) and the output layer (50C); and a calculation section (9) configured to calculate a first calculation result (30), by inputting input data (71) to the machine learning model (80) so as to perform inference, and to calculate a second calculation result (31), by inputting output data (dol) included in the output layer (50C) of the first calculation result (30) to the machine learning model (80) so as to perform inference, and to calculate an intermediate layer error (da3), on the basis of first intermediate data (20) included in the intermediate layer (50B) of the first calculation result (30), and second intermediate data (21) included in the intermediate layer (50B) of the second calculation result (31) (first configuration).

In the machine learning device (6) according to the first configuration, the first intermediate data (20) includes a first intermediate layer vector (ha) as a feature vector of the intermediate layer (50B), in a result of performing inference by inputting the input data (71) to the machine learning model (80), the second intermediate data (21) includes a second intermediate layer vector (hb) as a feature vector of the intermediate layer (50B), in a result of inputting the output data (do1) to the machine learning model (80), and the calculation section (9) calculates the intermediate layer error (da3) by a loss function (L) on the basis of the first intermediate layer vector (ha) and the second intermediate layer vector (hb) (second configuration).

In the machine learning device according to the first or second configuration, the calculation section (9) calculates an input-output error (the input-output error da1) by the loss function (L) on the basis of the input data (71) and the output data (do1) (third configuration).

An electronic device (100A) comprises the machine learning device (6) according to any one of the first to third configurations (fourth configuration).

A machine learning program (P) is a program for realizing a function as the machine learning device (6) according to any one of the first to third configurations (fifth configuration).

A simulation device (100) is configured to calculate the output data (do1) and the intermediate layer error (da3) using the machine learning device (6) according to any one of the first to third configurations (sixth configuration).

An abnormality level calculation method is an abnormality level calculation method using a machine learning device (6) including a model holding section (8) configured to hold a machine learning model (80) including an input layer (50A), an output layer (50C), and at least one intermediate layer (50B) disposed between the input layer (50A) and the output layer (50C), and a calculation section (9) configured to be capable of calculating a calculation result by inputting predetermined input data (71) to the machine learning model (80) so as to perform inference, and calculating an intermediate layer error (da3) on the basis of a plurality of calculation result, the method comprising the step (St1) of calculating a first calculation result (30) as the calculation result, by inputting first input data (71) as the input data (71) to the machine learning model (80) so as to perform inference; the step (St2) of calculating a second calculation result (31) as the calculation result, by inputting output data (do1) included in the output layer (50C) of the first calculation result (30) to the machine learning model (80) so as to perform inference; and the step (St3) of calculating intermediate layer error (da3), on the basis of first intermediate data (20) included in the intermediate layer (50B) of the first calculation result (30), and second intermediate data (21) included in the intermediate layer (50B) of the second calculation result (31) (seventh configuration).

What is claimed is:

1. A machine learning device comprising:
a model holding section configured to hold a machine learning model including an input layer, an output layer, and at least one intermediate layer disposed between the input layer and the output layer; and
a calculation section configured to calculate a first calculation result, by inputting input data to the machine learning model so as to perform inference, and to calculate a second calculation result, by inputting output data included in the output layer of the first calculation result to the machine learning model so as to perform inference, and to calculate an intermediate layer error, on the basis of first intermediate data included in the intermediate layer of the first calculation result, and second intermediate data included in the intermediate layer of the second calculation result.

2. The machine learning device according to claim 1, wherein
the first intermediate data includes a first intermediate layer vector as a feature vector of the intermediate layer, in a result of performing inference by inputting the input data to the machine learning model,
the second intermediate data includes a second intermediate layer vector as a feature vector of the intermediate layer, in a result of inputting the output data to the machine learning model, and
the calculation section calculates the intermediate layer error by a loss function on the basis of the first intermediate layer vector and the second intermediate layer vector.

3. The machine learning device according to claim 1, wherein
the calculation section calculates an input-output error by a loss function on the basis of the input data and the output data.

4. An electronic device comprising the machine learning device according to claim 1.

5. A machine learning program for realizing a function as the machine learning device according to claim 1.

6. A simulation device configured to calculate the output data and the intermediate layer error using the machine learning device according to claim 1.

7. An abnormality level calculation method using a machine learning device including a model holding section configured to hold a machine learning model including an input layer, an output layer, and at least one intermediate layer disposed between the input layer and the output layer, and a calculation section configured to be capable of calculating a calculation result by inputting predetermined input data to the machine learning model so as to perform inference, and calculating an intermediate layer error on the basis of a plurality of the calculation results, the method comprising the steps of:
calculating a first calculation result as the calculation result, by inputting first input data as the input data to the machine learning model so as to perform inference;
calculating a second calculation result as the calculation result, by inputting output data included in the output layer of the first calculation result to the machine learning model so as to perform inference; and
calculating the intermediate layer error, on the basis of first intermediate data included in the intermediate layer of the first calculation result, and second intermediate data included in the intermediate layer of the second calculation result.
